(19) United States
(12) Patent Application Publication
(10) Pub. No.: US 2025/0021989 A1
(43) Pub. Date: Jan. 16, 2025

(54) POLICY SERVICE AND INTERVENTION SYSTEM

(71) Applicant: DISCORD INC., San Francisco, CA (US)

(72) Inventors: Jonas Bengtson, San Francisco, CA (US); Ethan Breder, Snohomish, WA (US); Jeremy Dunck, San Bruno, CA (US); Jeffrey Halmich, JR., Orinda, CA (US); Mark Hanson, Sarasota, FL (US); Austin Liou, San Francisco, CA (US); Ryan Weinstein, San Francisco, CA (US)

(21) Appl. No.: 18/349,913

(22) Filed: Jul. 10, 2023

(51) Int. Cl. G06Q 30/018; G06Q 50/00

(52) U.S. Cl. CPC G06Q 30/018; G06Q 50/01

(57) ABSTRACT

The present technology provides a workflow engine that creates custom workflows of sequential tasks with various dependencies and an input of a particular dataset of objects that needs to be operated on or analyzed to result in an intended output. The customization can include a number and order of sequential workflow steps as well as a number and function of jobs to be executed in parallel at each of the workflow steps. When the workflow jobs are ready to be run, they may be queued up with an asynchronous task message server that services a server that supports near real-time communications. The asynchronous task service may be a message-oriented middleware that provides a queue to parallelize tasks.

### BACKGROUND

Some social networks are developed around friendships, professional relationships, or other individual connections, and some social networks create communities around topics. Often social networking platforms provide services through which users can form or interact within a social network. While social networks can provide entertainment, networking, commercial, or informational value, they are also subject to various challenges. Social networking platforms and broadcast social media platforms, like other technology platforms, may run into a scaling issue when it comes to content moderation. Exactly how messages are evaluated in determining whether they violate a policy has been generally a “black box” or too simple for users. As such, when users are faced with unclear or unfair policies, they are less likely to comply or improve in behavior, or even support such safety and content moderation services.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system configured to support user accounts in creating, managing and participating in online communities in accordance with some aspects of the present technology.

FIG. 2A illustrates an example of a user interface presented by a client application in accordance with some aspects of the present technology.

FIG. 2B illustrates an example of a user interface presented by a client application in accordance with some aspects of the present technology.

FIG. 3 illustrates an example diagram depicting an example system architecture of a safety/moderation service in accordance with some aspects of the present technology.

FIG. 4 illustrates an example diagram depicting read and write actions of a safety record database that is an immutable database in accordance with some aspects of the present technology.

FIG. 5A illustrates an example policy configuration for determining an appropriate intervention in accordance with some aspects of the present technology.

FIG. 5B illustrates an example log of a policy violation in accordance with some aspects of the present technology.

FIG. 6 illustrates an example flowchart diagram for determining a classification for a policy violation and storing the classification and policy violation at in an immutable database with some aspects of the present technology.

FIG. 7 illustrates an example flowchart diagram for determining an accrual of points that is associated with an intervention ladder for determining an intervention for a policy violation in accordance with some aspects of the present technology.

FIG. 8 illustrates an example of a computing system for implementing some aspects of the present technology.

### DETAILED DESCRIPTION

Various embodiments of the disclosure are discussed in detail below. While specific implementations are discussed, it should be understood that this is for illustration purposes only. A person skilled in the relevant art will recognize that other components and configurations may be used without parting from the spirit and scope of the disclosure.

Additional features and advantages of the disclosure will be set forth in the description which follows, and in part, will be obvious from the description or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by practicing the principles set forth herein.

For most large-scale broadcast social media platforms, content moderation is either not administered by a clear rule-based system (e.g., users don't get any visibility as to why their account has been banned or suspended) or is administered by a clear but rigid system that fails to apply proportional interventions (e.g., a 10 strikes and the user is suspended, with no exceptions). Content moderation without clear rules or content moderation that is based on a overly simplified rule is not only dangerous but also detrimental to the retention of users. When users are met with inconsistent or arbitrary decisions regarding what content is allowed or prohibited, they become frustrated and lose trust in the platform. Without clear guidelines or proportional interventions, there is a lack of transparency and trust, leading to confusion and uncertainty among users about what is acceptable behavior. This ambiguity creates an environment where users fear their content may be removed or their accounts suspended without clear justification, stifling their freedom of expression. To maintain a healthy and engaged user base, platforms must establish transparent and well-defined and fair rules that promote consistency and user confidence.

Furthermore, content moderation for large-scale broadcast social media platforms, such as a community hosting service, needs to be handled in a way that not only provides transparency as to why certain interventions occur for certain content and not for others but also provides such moderation in a timely manner. With near-real-time communication occurring between users in various channels for a community hosting service that has millions of different channels, being able to scale the content moderation is important, such that improper conduct is handled in a timely and scalable manner.

As such, the disclosed technology addresses the need for an architecture for content moderation that implements safety policies in a way that is clear and explainable to end users and is also built on a scalable model. Specifically, the disclosed technology combines a classification technology for determining harmful speech or actions with storing a history of allegations and interventions in an immutable safety record. In addition, points may be accrued based on repeated policy violations, such that proportional interventions are applied as points accrue.

The architecture for a safety/moderation service that implements such safety policies may include three aspects.

First, the safety/moderation service may include a detection service that generates signals and issues policy violations with respective classifications based on the generated signals. Each type of policy violation may be associated with a different classification (e.g., harassment, hate speech, bullying, piracy, etc.). For actions to qualify as a policy violation that falls until a specific type of classification, signals may be first generated and analyzed. Signals may include observation data associated with actions that triggered a generation of the signal based on a rule-based or machine-learning-based model. For example, a signal may include that a user has sent an image that some other users have identified as inappropriate in some circumstances. A collected set of signals associated with a set of actions may result in a determination that an entity associated with the set of signals has performed a collective action that amounts to a policy violation in a particular classification. For example, a user may send a number of unsolicited images to another user and once enough signals indicate that the unsolicited images amount to harassments, the user may receive a policy violation for a particular classification associated with harassment.

Second, the safety/moderation service may include an orchestration service that aggregates the policy violation decisions and applies policy definitions or interventions accordingly. The orchestration service may include a safety record service and a policy service. The safety record service may store classifications and associated policy violations in a safety record database as an immutable database to serve as a single source of truth. The policy service may consume the data from the safety record database and determine how to apply the policies accordingly. Lastly, the safety/moderation service may include an intervention service that receives the determined policies and applies the appropriate interventions at the community hosting service.

Specifically, the safety record service of the orchestration service may store immutable append-only records of relevant safety events that may be keyed on entities that can be considered potential “bad” actors, e.g., users, servers, etc. The relevant safety events may include signals of potential bad behavior, confirmation of such bad behavior, actions users have taken to remediate their bad behavior, actions the platform has taken in response to the bad behavior, etc.

The safety record service may further monitor and facilitate different interactions with the safety record database. For example, the detection service may read the state of the safety record database. The policy service may determine what the changes are and what is the current state for any given user and make a policy decision and determine a respective intervention associated with a particular user. The policy service may then push a request for the respective intervention to the intervention service.

The policy service of the orchestration service may include a policy configuration that is made up of a set of intervention ladders. The intervention ladders may describe escalating interventions that should take place as the user accrues points under each classification. For example, if there is a policy violation associated with harassment for a user, points may be accrued on an intervention ladder associated with harassment such that if there is another policy violation associated with piracy by the same user, a different point accrual process associated with a different intervention ladder associated with piracy is activated. This is important for determining proportional interventions since interventions against harassment may are different from interventions against piracy.

Furthermore, the policy configuration is statically validated to avoid any mistakes written into the safety rules. The safety rules may be implemented by policy service writers (e.g., policy service administrators for the entire platform or policy service administrators for a particular community/server), who may be non-technical. Therefore, the policy configuration is created to be a simple static configuration with a simple validation. In addition, the configuration can be simulated to generate an output that is based on example user safety history. This enables policy writers to make informed decisions by adjusting the configuration and observing the number of users affected by the change, ultimately determining the appropriate level of policy stringency. Policy configurations may further designate a classification tolerance level when issuing policy violations associated with a particular classification.

The intervention ladders may be associated with a particular classification of type of harm and may have a plurality levels. The levels may be associated with a particular point value for respective bad behaviors. The user may be incrementally “moving up” the ladder and the levels may be associated with different types of intervention. For example, for a harassment classification, using bullying language may be considered two points, moving up the ladder two levels. If there are no other policy violations for harassment assigned to the user, at level two, the intervention may just be a warning. However, if the user has had a history of harassment, moving up two levels may result in landing on a higher level, which could be associated with a temporary ban.

In addition, proportional interventions may also consider the type of actions that are being performed. For example, image-based abuse may result in image-based interventions, behavioral-based abuse of posting too much may result in limiting the ability to post for a number of hours, and if a user is using a server to host pirated movies, that user may be prohibited from uploading or hosting files. There may also be customization for servers or channels of the community hosting service. Different types of harm may be chosen for intervention, and different point values may be assigned to the different levels such that how the policy is configured may be customized. Furthermore, there may be a statute of limitations that is set for resetting point values.

The architecture for implementing safety policies may also be extended beyond safety policies. Taking classifications and signals based on users' actions and categorizing those users' actions in classifications to output various other actions based on a point system may be extended to personalization, determining relevance, determining rank, etc.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as data collection and/or use changes.

Although the present disclosure broadly covers the use of personal information data to implement one or more various disclosed embodiments, the present disclosure also contemplates that the various embodiments can also be implemented without the need for accessing such personal information data. The various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

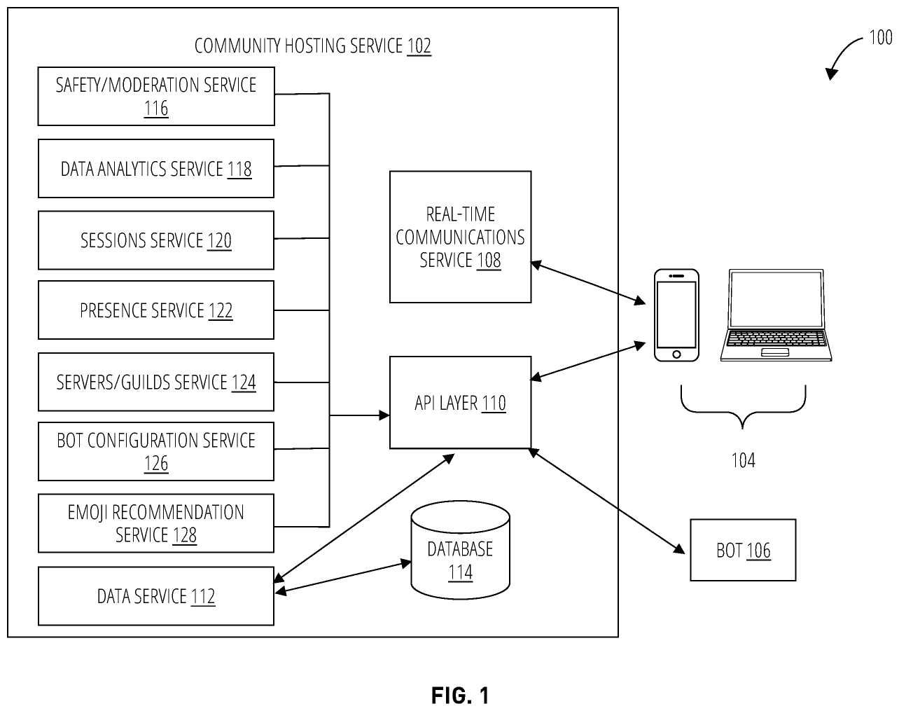

FIG. 1 illustrates an example system 100 configured to support user accounts in creating, managing and participating in online communities. In particular, the system 100 supports a plurality of user accounts interacting with each other in communities to which they belong.

The system 100 illustrates an example architecture in which users of user accounts interact through an instance of client application 104 operating on a computing device. The client application 104 can be provided by a webpage rendered in a web browser or a downloaded client application executed by an operating system of the computing device. In some embodiments, some disparate collections of features or functionality might be available in client application 104 depending on the capabilities of the environment executing or rendering the client application 104.

The system 100 also includes a community hosting service 102, which provides an infrastructure for supporting the plurality of user accounts interacting with each other in communities to which they belong. The community hosting service 102 can be a distributed service hosted in a cloud computing architecture. The community hosting service 102 is responsible for hosting various services accessible to the user accounts by the client application 104.

In some embodiments, the community hosting service 102 provides a servers/guilds service 124 to enable user accounts to set up a server (also referred to as a guild) to host members interacting around one or more channels. A server (or guild) is a user-created environment supporting a community. A server is generally configured with one or more channels which are generally created around topics or sub-topics, or groups of people, and can support exchanges of communications between user accounts. Some channels are non-real-time channels where users communicate through written messages, images, emojis, recorded voice or video files, attachments, etc. Some channels are real-time communications channels that support voice or video communications. Some channels may be able to support both non-real-time messaging and real-time communications.

A user account can operate their instance of the client application 104 to create a server at the community hosting service 102. In some embodiments, this will be performed by the client application 104 calling the API layer 110 requesting to create a new server. The API layer 110 can then interact with servers/guilds service 124 to create the server by providing the server with a unique identifier and associating various configurations requested by the user account. Once the server is created, the user account that created the server can be considered the owner and/or admin for the server. The servers/guilds service 124 can record the information about the server using data service 112 to store information about the server in database 114.

In some embodiments, servers can be configured to be public or private. A public server is one that any user can search for and request to join. A private server is one that a user needs to be invited to join. Depending on the configuration of the private server, a user can be invited by another user or may need to be invited by the administrator of the private server. Users can request to join a public or private server, and an entity with administrative privileges can grant the request.

In some embodiments, servers can be managed by the user account that created the server. Additionally, server administrators can delegate privileges to other user accounts to be administrators, and administrators can also create or invite bot 106, such as a chatbot, to perform some administrative actions.

In addition to approving user accounts to join a server, administrators can also set up various safety or content moderation policies. In some embodiments, those policies are enforced by user accounts with the administrator role for the server. In some embodiments, the policies can be enforced by software services provided by the community hosting service 102, such as the safety/moderation service 116 or bot 106.

As introduced above, servers are environments for supporting a community and are generally created around topics. In furtherance of that function, servers can be configured to integrate content through embedded channels or webhooks. For example, an administrator of a server might integrate a YOUTUBE channel, a TWITCH feed, or a TWITTER feed into one or more channels of the server when the content of those channels or feeds are relevant to the channel. In some embodiments, a server can follow a channel offered by another server supported by the community hosting service 102.

In addition to hosts, user accounts that are members of a server can also use their instance of client application 104 to interact with the community hosting service 102. The client application 104 can make requests of the community hosting service 102 to initiate a session with the community hosting service 102 and to access servers and channels to which the user account is a member, receive notifications and send messages, and otherwise communicate in the channels in which they belong.

As illustrated in FIG. 1, community hosting service 102 provides a variety of services that can be called by client application 104 or other services of the community hosting service 102.

For example, the community hosting service 102 includes a servers/guilds service 124. The servers/guilds service 124, as described above, can be used to create and administer a server. Additionally, the servers/guilds service 124 can also support various functions to those user accounts that are members of a server. For example, when an instance of client application 104 establishes a session using sessions service 120, the sessions service 120 can interact with servers/guilds service 124 to provide information regarding the servers to which the user account belongs. The client application 104 can receive identifiers of all servers to which the user account operating the client device associated with client application 104 is a member. While the session is active, client application 104 can request updates regarding one or more of the servers to which the user account operating client application 104 belongs from servers/guilds service 124.

Community hosting service 102 also provides a safety/moderation service 116. As with any online community, community hosting service 102 occasionally needs to deal with user accounts issuing spam or inappropriate content. While administrators of servers can perform some moderation functions such as suspending user accounts on a particular server or banning user accounts or bots for inappropriate posts or for posting spam, community hosting service 102 can have various software services that attempt to moderate some posts. For example, safety/moderation service 116 can include algorithms designed to detect hate speech or other harmful or inappropriate content. Safety/moderation service 116 can also include algorithms configured to identify communications as spam or phishing. Safety/moderation service 116 can provide various functions to protect users from content posted in a channel and attacks on client application 104 or the computing device hosting client application 104.

Community hosting service 102 can also include a data analytics service 118. The data analytics service 118 can provide various services in support of community hosting service 102 and in support of the users of community hosting service 102. For example, data analytics service 118 can monitor the performance of various features of the community hosting service 102 to determine whether updates to features are well received by the user community. The data analytics service 118 can also be used to develop and run various machine learning algorithms and other algorithms designed to identify harmful content, malicious servers, malicious user accounts, and malicious bot.

As introduced above, sessions service 120 is configured to authenticate a user account to community hosting service 102. After a user account has been authenticated, the sessions service 120 can determine one or more servers to which the user account is a member or for which the user account is an administrator. The sessions service 120 can send a list of identifiers for the servers associated with the user account to the client application 104. Thereafter, the client application 104 can request information regarding the servers by using a session token that validates that the client application 104 is operating in an authenticated session.

The presence service 122 can be used to provide presence information regarding other members of a server or a channel to which the user account belongs. Through the presence service 122, the client application 104 can convey information about which user accounts are currently active in the server or channel. Likewise, the client application 104 can provide presence information for the user account controlling the instance of client application 104.

Community hosting service 102 can also include a real-time communications service 108. The real-time communications service 108 is configured to support real-time communications such as live voice communications or video conferencing. In some embodiments, the real-time communications service 108 can be a public Internet service located outside a gateway for community hosting service 102. Real-time communications service 108 can provide real-time communications for channels configured to support real-time communications.

FIG. 1 also illustrates a bot configuration service 126 for creating and/or configuring one or more bot 106. The bot configuration service 126 can provide tools and template configurations to configure bots to take on a variety or roles within a channel of a server. The bot 106 can be created and configured by users of the community hosting service 102 and linked to servers chosen by the administrator. In some embodiments, the bot 106 can be configured as a chatbot that can have some understanding of the human language through natural language processing technologies. The bot 106 can be configured to provide some content moderation functions and/or some administrative functions. For example, the bot 106 might be granted permission to invite new members, send messages in a channel, embed links, remove members, delete messages, mute members, and attach files, among other possible functions. In some embodiments, bot 106 can have their own user account and are authenticated using a token. Bot 106 can have full access to all services of community hosting service 102.

FIG. 1 also illustrates an emoji recommendation service 128 for generating a ranking of emojis for a particular user in a particular server. The emoji recommendation service 128 can provide top ranked emojis to users when they are drafting messages at the server to be added to their messages. The ranking of the emojis may be determined based on a similarity score between a global emoji embedding space of an online community (i.e., one of the servers) with a user embedding space generated from the global emoji embedding space and generating a ranking of top emojis based on the measured similarity score in accordance with some aspects of the present technology. Furthermore, the global emoji embeddings may be created in an embedding space. The global emoji embeddings may comprises vectors representing past emoji usage by users in an online community over a period of time. In some cases, the emoji recommendation service 128 may be a part of or interfaces with the servers/guilds service 124.

While the community hosting service 102 is shown with just one of each service and database, it will be appreciated by those of ordinary skill in the art that community hosting service 102 can include many instances of each service or database, and in some embodiments, there can be different versions of the service or database that may utilize different technologies such as coding languages, database schemes, etc.

In some embodiments, the community hosting service 102 is configured such that the majority of communications between the community hosting service 102 and the client application 104 pass through API layer 110. The client application 104 can request responses from various services provided by the community hosting service 102 from the API layer 110. Additionally, services within the community hosting service 102 can communicate with each other by sending messages through the API layer 110. The client application 104 can also interact with a real-time communications service 108 for voice and video communication services. Although the community hosting service 102 is be described with respect to a particular system architecture and communication flow, it will be appreciated by those of ordinary skill in the art that other system configurations are possible.

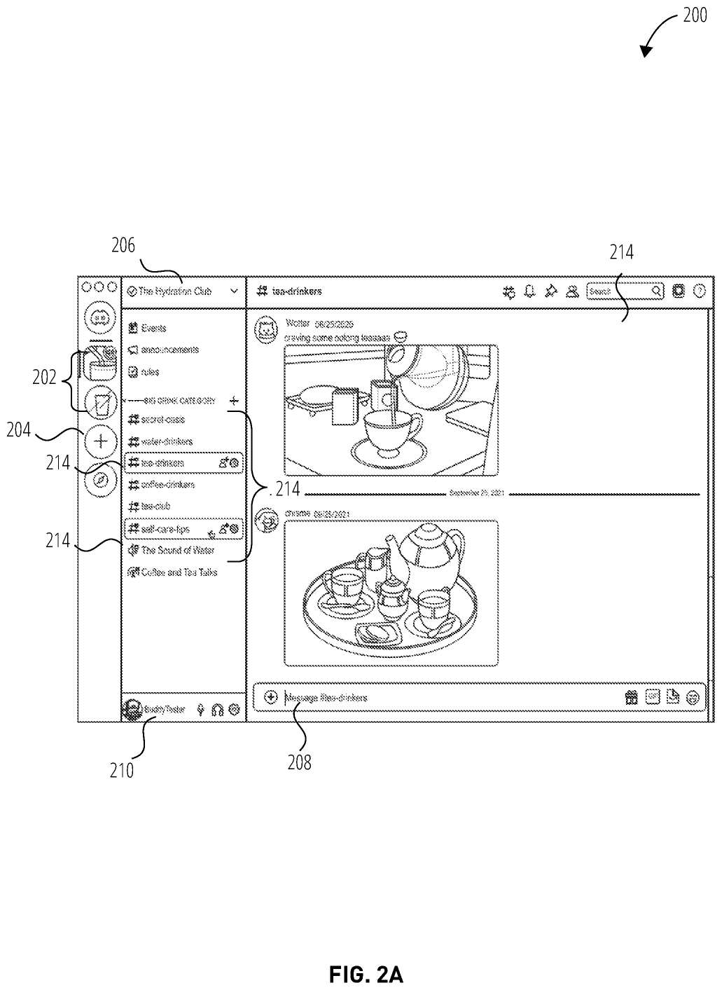

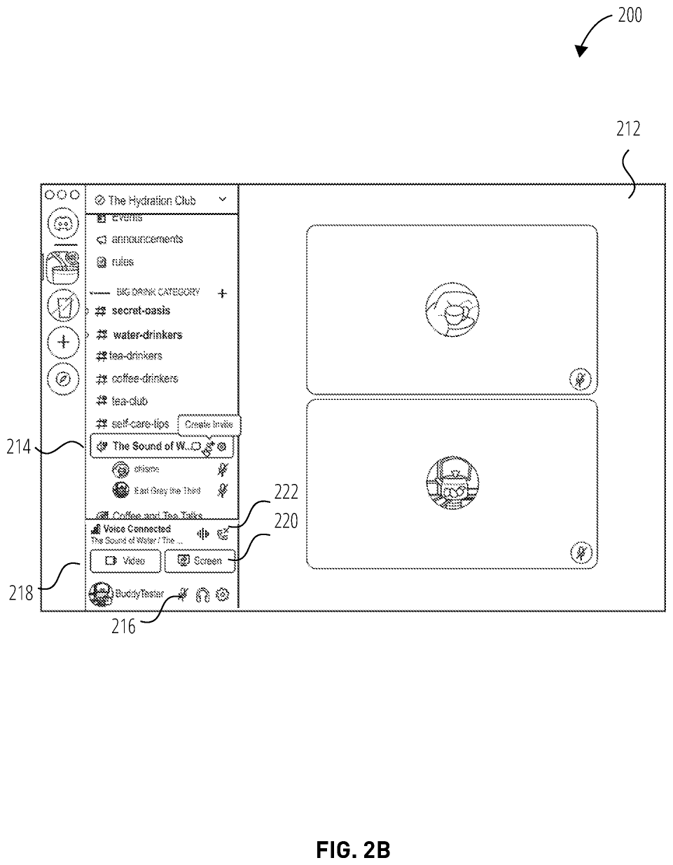

FIG. 2A illustrates an example of user interface 200 presented by client application 104.

User interface 200 includes icons for servers 202. The top icon has been selected and represents the “hydration club” server. The title 206 of the selected server, the “hydration club,” is presented at the top of the user interface 200. User interface 200 also includes an options 214 that are part of the server hydration club server. options 214, entitled “tea drinkers”, is a non-real-time messaging channel. The message thread within the “tea drinkers” channel can be shown within options 214. As illustrated in FIG. 2A, the options 214 is configured to present content such as text messages, images, emojis, recorded voice or video files, attachments, etc. A user can provide content to be included in the channel using input interface 208. The server 202 includes options 214 entitled “sound of water” as further described in FIG. 2B.

User interface 200 also includes a selectable option 204 to add additional servers. User interface 200 also includes a user account icon and controls 210.

FIG. 2B illustrates another example of user interface 200 presented by client application 104. In FIG. 2B, channel 214 entitled “sound of water” has been selected. The “sound of water” channel is a real-time communications channel. Accordingly, messaging pane 212 shows two user accounts engaged in real-time communications. As illustrated in FIG. 2B, the user account icon and controls 210 show that the user account's microphone 216 is muted. Additionally, the user account has option 218 or option 220 to share their video or screen, respectively. The user account can also disconnect from the real-time communications using option 222.

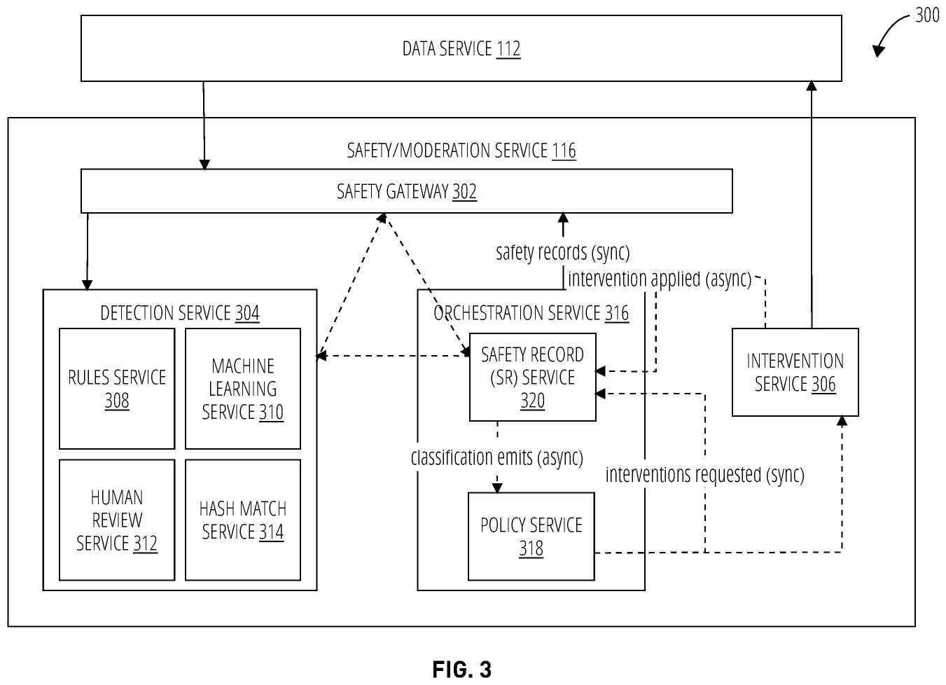

FIG. 3 illustrates an example diagram depicting an example system architecture of a safety/moderation service in accordance with some aspects of the present technology.

As previously discussed, the disclosed technology addresses the need for an architecture for content moderation that implements safety policies in a way that is clear and explainable to end users and is also built on a scalable model. Specifically, the disclosed technology combines a classification technology for determining harmful speech or actions with storing a history of allegations and interventions in an immutable safety record. In addition, points may be accrued based on repeated policy violations, such that proportional interventions are applied as points accrue.

The architecture for a safety/moderation service that implements such safety policies. The safety/moderation service 116 may be a service of the community hosting service 102 or be a separate service. The safety/moderation service 116 may interface with the data service 112, which may store various data such as signals, policy violations, classifications, and interventions. In some cases, the data service 112 stores a safety record database that is an immutable database that records the various policy violations, classifications, and interventions associated with various entities.

The safety/moderation service 116 may include a safety gateway 302 that serves as an entry point or interface for incoming user data and is also responsible for forwarding such data to the detection system for further processing. The safety gateway 302 may serve as a connection point to transmit data related to signals, classifications, interventions, and other types of safety records. The detection service 304 may then utilize the user data to issue classifications and generate signals based on predefined rules, machine learning algorithms, or human review.

The safety/moderation service 116 may include a detection service 304, which may further include various services such as a rules service 308, a machine learning service 310, a human review service 312, and a hash match service 314.

The rules service 308 may store rules that define certain behavior that are more clear-cut. For example, if a user tries to log-in from five different IP addresses, they are considered a spammer. The hash match service 314 may assist with matching image hashes against a known database. The human review service 312 may provide an ability for a human to review the history of policy violations, signals, and classifications for the entities of the community hosting service 102. By providing an ability to view a safety record database that stores the history of an immutable database that serves as a single source of truth, a human may be a final check for fine-tuning the policy violation determination process. Being able to provide a history of what was accused, what interventions were requested and applied, and if any accusations were appeals provides the kind of clarity and transparency that users want.

Through the various services, the detection service 304 may generate signals. The generated signals may include syntax that gives context to the signal, such as a signal event identifier, an actor of the signal event (such as an entity), a content identifier (identifiers associated with content that the signal is related to), reason identifier (an idea that points to an object with variably structured data representing a reason the signal was generated), a source (a strong with human readable information that explains the source of the signal), a human readable name of the string type, ad a timestamp.

The machine learning service 310 may learn to determine policy violations for specific classifications from received signals based on training data that includes sets of activities at the community hosting service 102 and corresponding types of signals and policy violations for specific classifications. Signals may include any type of activity that could eventually amount to a policy violation. For example, one type of policy violation for a classification for “harassments” may require that a user send a certain number of unsolicited messages. One signal may include that a first user sent a number of messages to a second user. Another signal may indicate that the second user blocked the first user. These two signals together may indicate that the first user's conduct amounts to a policy violation for a specific harassment-type classification.

The safety/moderation service 116 may also include an orchestration service 316 that aggregates the policy violation decisions and applies policy definitions or interventions accordingly. The orchestration service 316 may include a safety record service 320 and a policy service 318.

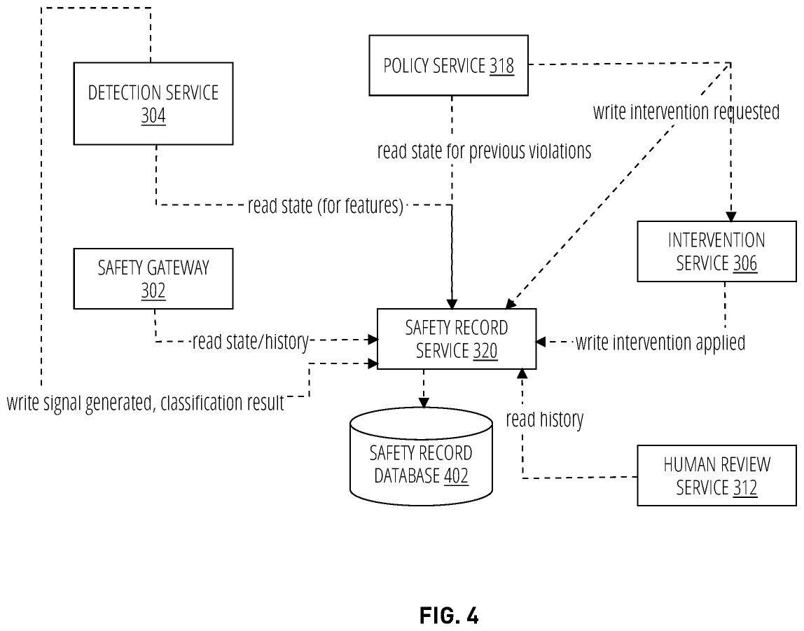

The safety record service 320 of the orchestration service 316 may monitor and facilitate different interactions with a safety record database. The safety record service 320 may further store classifications and associated policy violations in a safety record database 402 (see FIG. 4), which may be stored at the data service 112 or separately. The safety record database 402 is an immutable database to serve as a single source of truth. The policy service 318 may consume the data from the safety record database 402 and determine how to apply the policies accordingly.

Specifically, the safety record service 320 of the orchestration service 316 may store immutable append-only records of relevant safety events that may be keyed on entities that can be considered potential “bad” actors, e.g., users, servers, etc. The relevant safety events may include signals of potential bad behavior, confirmation of such bad behavior, actions users have taken to remediate their bad behavior, actions the platform has taken in response to the bad behavior, etc.

The policy service of the orchestration service may include a policy configuration that is made up of one or more intervention ladders. The intervention ladders describe escalating interventions that should take place as the user accrues points under the classifications. For example, if there is a policy violation associated with harassment for a user, points may be accrued in association with an intervention ladder for harassment. If there is another policy violation associated with hate speech by the same user, a different point accrual process associated with a different intervention ladder associated with hate speech is activated.

Furthermore, the policy configuration is statically validated to avoid any mistakes written into the safety rules. The safety rules may be implemented by policy service writers (e.g., policy service administrators for the entire platform, or policy service administrators for a particular community), who may be non-technical. Therefore, the policy configuration is created to be a simple static configuration with a simple validation. In addition, the configuration can be simulated to generate an output that is based on example user safety history. This enables policy writers to make informed decisions by adjusting the configuration and observing the number of users affected by the change, ultimately determining the appropriate level of policy stringency.

The safety/moderation service 116 may also include an intervention service 306 that receives the determined policies and applies the appropriate interventions at the community hosting service. The intervention ladders may be associated with a particular classification of type of harm and may have a plurality levels. The levels may be associated with a particular point value for the bad behaviors. The user may be incrementally “moving up” the ladder and the levels may be associated with different types of intervention. For example, for a harassment classification, teasing another user with mean analogies may be considered two points, moving up the ladder two levels. If there are no other policy violations for harassment assigned to the user, at level two, the intervention may just be a warning. However, if the user has had a history of harassment, moving up two levels may result in landing on level six, which may be associated with a temporary ban.

In addition, proportional interventions may also consider the type of actions that are being performed. For example, image-based abuse may result in image-based interventions, behavioral-based abuse of posting too much may result in limiting the ability post for a number of hours, and if a user is using a guild to host pirated movies, that user may be prohibited from uploading or hosting files. There may also be customization polices, points, or interventions by server or channel of the community hosting service. Different types of harm may be chosen for intervention, and different point values may be assigned to the different levels such that how the policy is configured may be customized. Furthermore, there may be a statute of limitations that is set for resetting point values.

Furthermore, in some cases, a log for requesting that the intervention is applied is stored separately from a log for applying the intervention at the safety record database 402. In some cases, the policy service 318 may not be aware of any context other than the classification history and the policy configuration. For example, the policy service 318 would not like if a entity was already enrolled in an intervention between it requested it or whether the entity was ineligible for a particular intervention. Such details are left to the intervention service 306. Therefore, whether intervention was requested or applied are stored as separate logs in the safety record database 402.

The architecture for implementing safety policies may also be extended beyond safety policies. Taking classifications and signals based on users actions and categorizing those users actions in classifications to output various other actions based on a point system may be extended to personalization, determining relevance, determining ranking, etc.

FIG. 4 illustrates an example diagram depicting read and write actions of a safety record database that is an immutable database in accordance with some aspects of the present technology.

The safety record service 320 may read and write into a safety record database 402 that serves as an immutable database based on requests from other services. For example, the detection service 304 may request to read the state of the safety record database 402 for features to generate signals or classifications. The detection service 304 may also write the generated signals and classification results with the safety record database 402. The policy service 318 may request to read the state of the safety record database 402 for information about previous violations for determining the appropriate interventions. The policy service 318 may also write the requested interventions at the safety record database 402. The policy service 318 may determine what the changes are and what is the current state for any given user and makes a policy decision and respective intervention associated with a particular user. The policy service 318 may then push the respective intervention to an intervention service 306. The intervention service 306 may write interventions applied at the safety record database 402.

In addition, the human review service 312 may also request to read the history of the safety record database 402. Furthermore, the safety gateway 302 may serve as an interface for other services of the community hosting service 102 that may request to read the state or history of the safety record database 402.

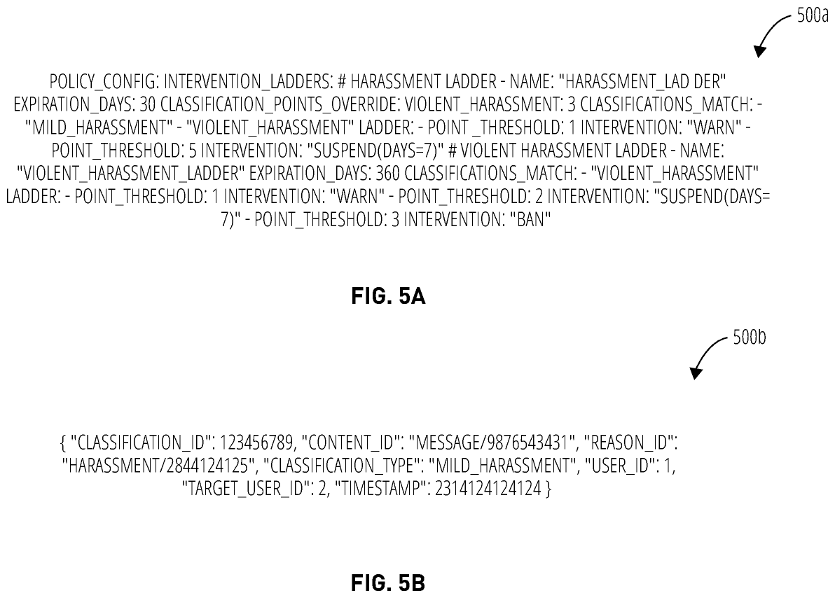

FIG. 5A illustrates an example policy configuration for determining an appropriate intervention in accordance with some aspects of the present technology.

As shown in the example policy configuration 500a, there may be different intervention_ladders for different or same types of policy violations. For example, there may be two different types of harassment ladders, such as a standard harassment ladder and a violent harassment ladder. A standard harassment ladder may have a 30 day expiration policy and a 3 point classification/policy violation override may add points to the standard harassment ladder and/or the violent harassment ladder. Classifications/policy violations that match “mild harassment” or “violent_harassment” may use the policy configuration for the standard harassment ladder.

FIG. 5B illustrates an example log of a policy violation in accordance with some aspects of the present technology.

A log of a policy violation 500b may include a classification identifier, a content identifier, a reason identifier, a classification type, a user identifier, a target user identifier, and a timestamp. For policy violation 500b with a classification type “mild_harassment”, the appropriate policy configuration is the standard harassment ladder. Since the standard harassment ladder expires after 30 days, 30 or more days of policy violation data needs to be retrieved from the safety record database 402. If there are not other policy violation data, this most recent policy violation increases the total point value associated with the standard harassment ladder to 1. The policy configuration indicates that for a point threshold of 1, an appropriate intervention is a warning. As such, the intervention service 306 may send a warning to the respective entity. However, if the entity has already accumulated 4 points, for example, adding the 1 point results in 5 points and a suspension intervention is initiated from the intervention service 306.

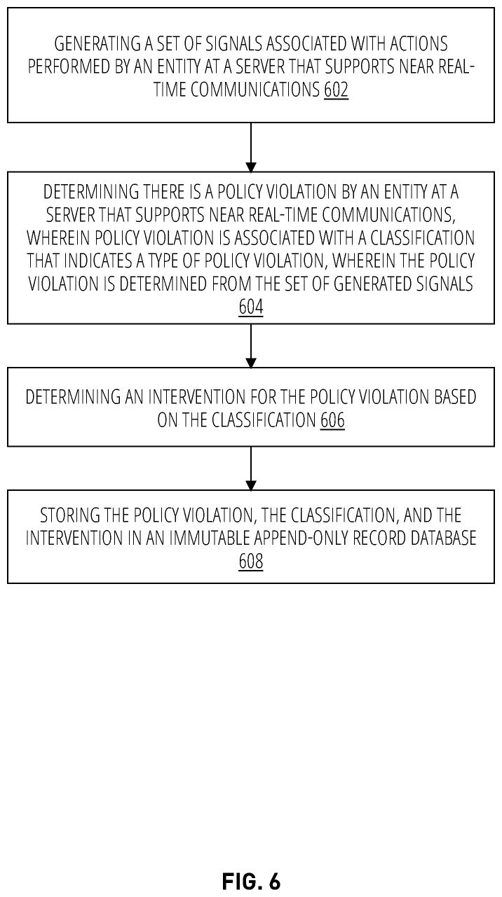

FIG. 6 illustrates an example flowchart diagram for determining a classification for a policy violation and storing the classification and policy violation at in an immutable database with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes generating a set of signals associated with actions performed by an entity at a server that supports near real-time communications at step 602. The set of signals may include observation data associated with actions that triggered the generation of each respective signal. For example, the safety/moderation service 116 and/or the community hosting service 102, illustrated in FIGS. 1, 3, and 4, may generate the set of signals.

According to some examples, the method includes determining that there is a policy violation by the entity at the server that supports near real-time communications at step 604. For example, the safety/moderation service 116 and/or the community hosting service 102, illustrated in FIGS. 1, 3, and 4, may determine there is a policy violation by the entity. In some cases, the determination that there is the policy violation may be determined based on a machine-learning model or a rule-based model. In some cases, the entity is a user or a community of users. In some cases, the policy violation is associated with a classification that indicates a type of policy violation. In some cases, the determination of the classification is based on the generated set of signals. The generated set of signals may be aggregated or analyzed to create a determination of a policy violation associated with a classification. For example, one of the signals may indicate that entity is storing large files in a database associated with a server and another signal may indicate that the entity sends messages including a large collection of new or unreleased movies, the policy violation may be associated with piracy.

According to some examples, the method includes determining an intervention for the policy violation based on the classification at step 606. For example, the safety/moderation service 116 and/or the community hosting service 102, illustrated in FIGS. 1, 3, and 4, may determine the intervention. In some cases, the intervention be a warning, a suspension, a ban, or a proportional intervention. For the example regarding piracy, a first intervention may be a warning. In some cases, the policy violation based on the classification may result in multiple interventions.

According to some examples, the method includes storing the policy violation, the classification, and the intervention in an immutable database at step 608. For example, the safety/moderation service 116 and/or data service 112 and/or the community hosting service 102, illustrated in FIGS. 1. 3, and 4, may store the policy violation, the classification, and the intervention in the immutable database. Furthermore, in some cases, a log for requesting that the intervention is applied is stored separately from a log for applying the intervention at the immutable database. In addition, classifications may be indexed by entities at the immutable database for easier access.

In some cases, the determination of the policy violation may be incorrect. Therefore, entities may have an option to appeal. The appeal may indicate that the determined classification is incorrect. In some cases, the safety/moderation service 116 determines a new classification for the policy violation or determine there was no policy violation. For example, a policy violation with a violent harassment classification may have been incorrect and only should have been a mild harassment classification. In other cases, the policy violation may have been a false positive and there was no violation. Either way, the appeal and the new classification or a correction that there was no policy violation is stored in the immutable database.

For the example regarding piracy, after a first intervention with the warning, the entity has an option to appeal. If they do not appeal, then another policy violation occurs, then the intervention may be escalated to a suspension from uploading or hosting files. With the warning and the appeal option provided in the history, the entity would find such proportional interventions to be more than reasonable. However, with the appeal option, if the first intervention warning should not have been given, and the escalation to suspension was then improper, the appeals process may fix the improper intervention. In some cases, the intervention service 306 may re-assess the request or receive requests to remove specific interventions. In some cases, the intervention service 306 may use an entity's intervention state to attempt to detect which interventions to remove, which ones to add, and which ones to mutate.

Furthermore, the appeals may be directly mapped to the respective classifications and may be used to create a feedback loop for tuning a rule-based or training a machine-learning model that sets the classifications.

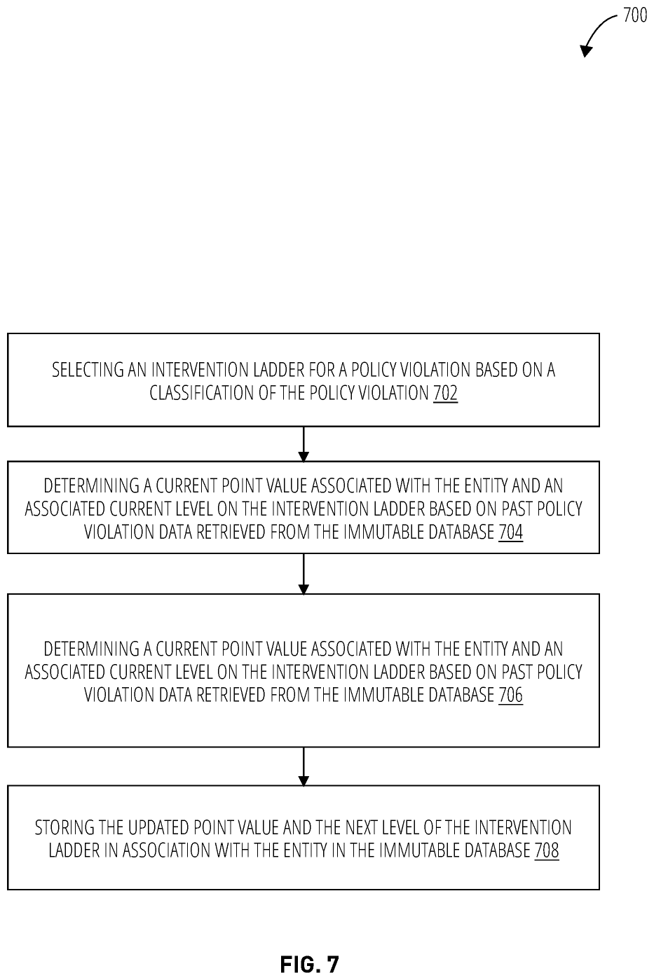

FIG. 7 illustrates an example flowchart diagram for determining an accrual of points that is associated with an intervention ladder for determining an intervention for a policy violation in accordance with some aspects of the present technology. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

According to some examples, the method includes selecting an intervention ladder for a policy violation based on a classification of the policy violation at step 702. For example, the safety/moderation service 116 and/or the community hosting service 102, illustrated in FIGS. 1, 3, and 4, may select an intervention ladder. A policy configuration may be made of up one or more intervention ladders. The intervention ladders may describe escalating interventions that should take place as the user accrues points under each classifications. For example, if there is a policy violation associated with harassment for a user, points may be accrued an intervention ladder associated with harassment such that if there is another policy violation associated with hate speech by the same user, a different point accrual process associated with a different intervention ladder associated with hate speech is activated.

According to some examples, the method includes determining a current point value associated with the entity and an associated current level on the intervention ladder based on past policy violation data retrieved from the immutable database at step 704. For example, the safety/moderation service 116 and/or the community hosting service 102, illustrated in FIGS. 1, 3, and 4, may determine the current point value and associate current level. In some cases, determining the current level may require retrieving classification or policy violation data. In some cases, if the expiration time period associated with an intervention ladder is 30 days, 30 days' worth or more of classification or policy violation data may be retrieved to determine the current level on the intervention ladder.

According to some examples, the method includes updating the current point value by adding one or more points based on the policy violation and updating a next level of the intervention ladder at block 706. For example, the safety/moderation service 116 and/or the community hosting service 102, illustrated in FIGS. 1, 3, and 4, may update the current point value. In some cases, each increasing level may be associated with a harsher intervention action. In some cases, the determined intervention is based on the updated point value.

According to some examples, the method includes storing the updated point value and the next level of the intervention ladder in association with the entity in the immutable database at block 708. For example, the safety/moderation service 116 and/or the community hosting service 102, illustrated in FIGS. 1, 3, and 4, may store the updated point value and the next level in the immutable database. In other cases, the point value is recalculated based on retrieved data from the immutable database.

Furthermore, with an expiration reset time period for each intervention ladder, after the expiration reset time period has passed without any other intervening policy violations associated with the intervention ladder, the updated point value may reset for the entity.

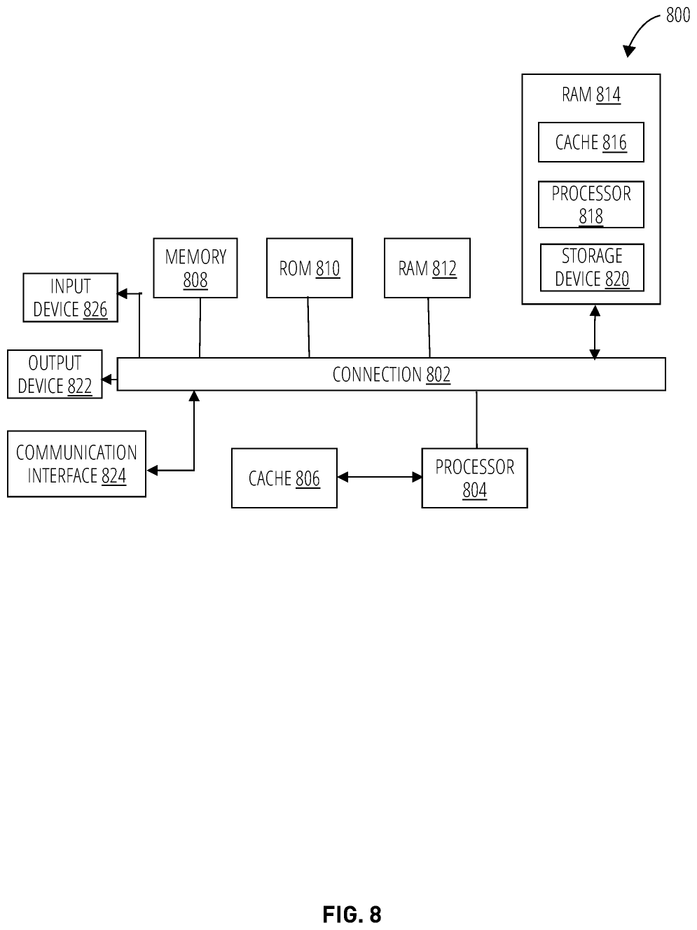

FIG. 8 shows an example of computing system 800, which can be for example any computing device making up client application 104, community hosting service 102, or any component thereof in which the components of the system are in communication with each other using connection 802. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache 806 of high-speed memory connected directly with, in close proximity to, or integrated as part of processor 804.

Processor 804 can include any general purpose processor and a hardware service or software service stored in storage device 820, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 820 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 820 can include software services, servers, services, etc., that when the code that defines such software is executed by the processor 804, it causes the system to perform a function. In some embodiments, a hardware service that performs a particular function can include the software component stored in a computer-readable medium in Connection with the necessary hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method comprising:
reading a state of an immutable database that stores a history of past policy violations at a server that supports near real-time communications, wherein the state includes previous policy violations by an entity at the server that supports near real-time communications;
determining there is a new policy violation by the entity at the server that supports near real-time communications, wherein the new policy violation is associated with a classification that indicates a type of policy violation and determined based on the previous policy violations;
determining an intervention for the policy violation based on the classification and the previous policy violations; and
storing the new policy violation, the classification, and the intervention in the immutable database.

2. The computer-implemented method of claim 1, wherein the determination that there is the new policy violation is determined based on a machine-learning model or a rule-based model.

3. The computer-implemented method of claim 1, wherein the entity is a community of users.

4. The computer-implemented method of claim 1, further comprising:
generating a set of signals associated with actions performed by the entity at the server that supports near real-time communications, wherein the new policy violation determination is based on the generated set of signals.

5. The computer-implemented method of claim 1, further comprising:
receiving an appeal indicating that the determined classification is incorrect;
determining a new classification for the new policy violation or that there was no policy violation; and
storing, in the immutable database, the appeal and the new classification or a correction that there was no policy violation.

6. The computer-implemented method of claim 1, further comprising:
requesting the intervention to be applied;
applying the intervention; and
storing a log for requesting the intervention to be applied separately from a log for applying the intervention in the immutable database.

7. The computer-implemented method of claim 1, further comprising:
indexing classifications by entities at the immutable database.

8. The computer-implemented method of claim 1, further comprising:
selecting an intervention ladder based on the classification;
determining a current point value associated with the entity and an associated current level on the intervention ladder based on past policy violation data associated with the previous policy violations; and
updating the current point value by adding one or more points based on the new policy violation and updating a next level of the intervention ladder, wherein each increasing level is associated with a harsher intervention action, wherein the determined intervention is based on the updated point value.

9. The computer-implemented method of claim 8, further comprising:
storing the updated point value and the next level of the intervention ladder in association with the entity in the immutable database.

10. The computer-implemented method of claim 8 further comprising:
setting an expiration reset time period for the intervention ladder; and
after the expiration reset time period has passed without any intervening policy violations associated with the intervention ladder, resetting the updated point value for the entity.

11. A non-transitory computer-readable storage medium, the computer-readable storage medium including instructions that when executed by a computer, cause the computer to:
read a state of an immutable database that stores a history of past policy violations at a server that supports near real-time communications, wherein the state includes previous policy violations by an entity at the server that supports near real-time communications;
determine there is a new policy violation by the entity at the server that supports near real-time communications, wherein the new policy violation is associated with a classification that indicates a type of policy violation and determined based on the previous policy violations;
determine an intervention for the policy violation based on the classification and the previous policy violations; and
store the new policy violation, the classification, and the intervention in the immutable database.

12. The computer-readable storage medium of claim 11, wherein the determination that there is the new policy violation is determined based on a machine-learning model or a rule-based model.

13. The computer-readable storage medium of claim 11, wherein the entity is a community of users.

14. The computer-readable storage medium of claim 11, wherein the instructions further configure the computer to:
generate a set of signals associated with actions performed by the entity at the server that supports near real-time communications, wherein the new policy violation determination is based on the generated set of signals.

15. The computer-readable storage medium of claim 11, wherein the instructions further configure the computer to:
receive an appeal indicating that the determined classification is incorrect;
determine a new classification for the new policy violation or that there was no policy violation; and
store, in the immutable database, the appeal and the new classification or a correction that there was no policy violation.

16. The computer-readable storage medium of claim 11, wherein the instructions further configure the computer to:
request the intervention to be applied;
apply the intervention; and
store a log for requesting the intervention to be applied separately from a log for applying the intervention in the immutable database.

17. The computer-readable storage medium of claim 11, wherein the instructions further configure the computer to:
index classifications by entities at the immutable database.

18. The computer-readable storage medium of claim 11, wherein the instructions further configure the computer to:
select an intervention ladder based on the classification;
determine a current point value associated with the entity and an associated current level on the intervention ladder based on past policy violation data associated with the previous policy violations; and
update the current point value by adding one or more points based on the new policy violation and updating a next level of the intervention ladder, wherein each increasing level is associated with a harsher intervention action, wherein the determined intervention is based on the updated point value.

19. The computer-readable storage medium of claim 18, wherein the instructions further configure the computer to:
store the updated point value and the next level of the intervention ladder in association with the entity in the immutable database.

20. A system comprising:
a processor; and
a memory storing instructions that, when executed by the processor, configure the system to:
read a state of an immutable database that stores a history of past policy violations at a server that supports near real-time communications, wherein the state includes previous policy violations by an entity at the server that supports near real-time communications;
determine there is a new policy violation by the entity at the server that supports near real-time communications, wherein the new policy violation is associated with a classification that indicates a type of policy violation and determined based on the previous policy violations;
determine an intervention for the policy violation based on the classification and the previous policy violations; and
store the new policy violation, the classification, and the intervention in the immutable database.
